(19) United States
(12) Patent Application Publication
(10) Pub. No.: US 2006/0214641 A1
(43) Pub. Date: Sep. 28, 2006

(54) Rechargeable battery module

(76) Inventor: Kyu-Woong Cho, Suwon-si (KR)

Correspondence Address: CHRISTIE, PARKER & HALE, LLP, PO BOX 7068, PASADENA, CA, 91109-7068, US

(21) Appl. No.: 11/372,663

(22) Filed: Mar. 10, 2006

(30) Foreign Application Priority Data
Mar. 25, 2005 (KR) 10-2005-0024864

(51) Int. Cl. H02J 7/04

(52) U.S. Cl. 320/150

(57) ABSTRACT

A rechargeable battery module includes a plurality of unit cells arranged at particular intervals; a heat sink plate mounted between the plurality of unit cells and adapted to dissipate heat generated by the plurality of unit cells; and at least one cooling channel positioned on a first side of the heat sink plate or penetrating through the heat sink plate and adapted to circulate a coolant. A method for dissipating heat from a plurality of unit cells arranged at particular intervals includes providing a heat sink having a channel adapted to circulate a coolant; positioning a heat sink between neighboring ones of the plurality of unit cells; and supplying a coolant to the channel.

### CROSS-REFERENCE TO RELATED APPLICATION

This application claims priority to and the benefit of Korean Patent Application No. 10-2005-0024864 filed in the Korean Intellectual Property Office on Mar. 25, 2005, the entire content of which is incorporated herein by reference.

### BACKGROUND

A rechargeable battery is generally distinguished from a primary battery in that it can be repeatedly charged and discharged.

A rechargeable battery with low capacity includes a unit cell, which is used for small portable electronic devices such as a mobile phone, a laptop computer, or a camcorder.

On the other hand, a rechargeable battery with high capacity includes a plurality of unit cells as a pack, and is commonly used as a power source for driving a motor of a hybrid electric vehicle and the like.

Rechargeable batteries are generally formed with a cylindrical or prismatic shape.

In addition, rechargeable batteries are connected in series to form a rechargeable battery module with a larger capacity than a single battery and can be used for driving a motor of an electric vehicle requiring a large amount of electrical power.

The rechargeable battery module generally includes a plurality of rechargeable batteries (hereinafter, referred to as unit cells for convenience).

The unit cells respectively include an electrode assembly, which is composed of positive and negative electrodes and a separator interposed therebetween, a case having a space for housing the electrode assembly, a cap assembly combined with the case and sealing it, and positive and negative terminals protruding through the cap assembly and electrically connected with the positive and negative electrodes of the electrode assembly.

The unit cells, which are generally formed with a prismatic shape, are connected to one another by using a nut that conductively links a positive terminal of one unit cell to a negative terminal of a neighboring cell, forming a rechargeable battery module.

The unit cells internally generate a large amount of heat as they are repeatedly charged and discharged. Accordingly, a rechargeable battery module including several or tens of unit cells should have the ability to easily dissipate the heat generated by the unit cells. The heat dissipation characteristic of a rechargeable battery module has a critical influence on the performance of the battery. When a battery module cannot properly dissipate heat, the heat generated by unit cells increases the temperature inside the battery, resultantly deteriorating battery performance.

In particular, when the rechargeable battery module is applied to a rechargeable battery with a large capacity for driving a motor, such as in an electric vacuum cleaner, an electric scooter, or an automobile (an electric vehicle or a hybrid electric vehicle), it is charged and discharged by a high current and proportionally generates more heat. The heat considerably increases the temperature inside the battery through an internal reaction thereof and has a disadvantageous influence on battery characteristics, deteriorating battery performance.

Therefore, the heat dissipation characteristic of a battery module plays a very important role in fabricating a battery with large capacity.

### SUMMARY OF THE INVENTION

A rechargeable battery module includes a plurality of unit cells arranged at particular intervals; a heat sink plate, mounted between the plurality of unit cells, adapted to dissipate heat generated by the plurality of unit cells; and at least one cooling channel, adapted to circulate a coolant, formed on a first side of the heat sink plate.

The heat sink plate may contact one side of one of the plurality of unit cells and at least one edge of the heat sink plate protrudes beyond the one side of the one of the plurality of unit cells. The heat sink plate may also include a material selected from the group consisting of aluminum, an aluminum alloy, and a metal composite material.

The at least one cooling channel may be formed as a groove on the first side of the heat sink plate, and may have a cross section selected from the group consisting of a square, a rectangle, a trapezoid, and an arch. The at least one cooling channel may also be formed on a second side of the heat sink plate, and the at least one cooling channel on the first side and the second side of the heat sink plate may be respectively aligned in a same direction, or in different directions.

The at least one cooling channel, in one embodiment, is formed as a hole penetrating the heat sink plate. In another embodiment is formed to have a curved structure. The curved structure may be curved at an edge of the heat sink plate at an angle of 180°.

One embodiment of the rechargeable battery module also includes a second heat sink plate, and a one of the plurality of unit cells is disposed between the heat sink plate and the second heat sink plate. In another embodiment, two or more of the plurality of unit cells are disposed between the heat sink plate and the second heat sink plate.

The heat sink plate may be supplied with air, water, or other suitable material as the coolant. In one embodiment, cold water is supplied to the heat sink.

The rechargeable battery module may be adapted for driving a motor of an electric device such as a hybrid electric vehicle (HEV), an electric vehicle (EV), a cordless vacuum cleaner, a motorbike, an electric scooter, or the like.

One embodiment of a rechargeable battery module includes a plurality of unit cells; a first heat sink plate positioned between neighboring ones of the plurality of unit cells and having at least one cooling channel; a coolant positioned within the at least one cooling channel.

Another embodiment of a method of dissipating heat from a plurality of unit cells arranged at particular intervals includes providing a heat sink having a channel adapted to circulate a coolant; positioning a heat sink between neighboring ones of the plurality of unit cells; and supplying a coolant to the channel.

### BRIEF DESCRIPTION OF THE DRAWINGS

FIG. 1 is a schematic exploded perspective view illustrating the structure of a rechargeable battery module according to an embodiment of the present invention.

FIG. 2 is a side view illustrating a heat sink plate of a rechargeable battery module according to another embodiment of the present invention.

FIG. 3 is a side view illustrating a heat sink plate of a rechargeable battery module according to yet another embodiment of the present invention.

FIG. 4 is a side view illustrating a heat sink plate of a rechargeable battery module according to an embodiment of the present invention.

FIG. 5 is a perspective view illustrating a heat sink plate of a rechargeable battery module according to another embodiment of the present invention.

FIG. 6 is a perspective view illustrating a heat sink plate of a rechargeable battery module according to yet another embodiment of the present invention.

FIG. 7 is a perspective view illustrating a heat sink plate of a rechargeable battery module according to an embodiment of the present invention.

FIG. 8 is a perspective view illustrating a heat sink plate of a rechargeable battery module according to another embodiment of the present invention.

FIG. 9 is a partial side view illustrating a rechargeable battery module according to the embodiment shown in FIG. 1.

FIG. 10 is a partial side view illustrating a rechargeable battery module according to an embodiment of the present invention.

FIG. 11 is a block chart illustrating the connection status of a rechargeable battery module according to an embodiment of the present invention with a motor.

### DETAILED DESCRIPTION

Hereinafter, the present invention is illustrated in detail based on examples of embodiments with reference to the accompanying drawings.

Some embodiments of the rechargeable battery module of the invention adopt a cooling method using air. However, the present invention is not limited thereto, and it can include other materials as a coolant, such as cold water or other liquids.

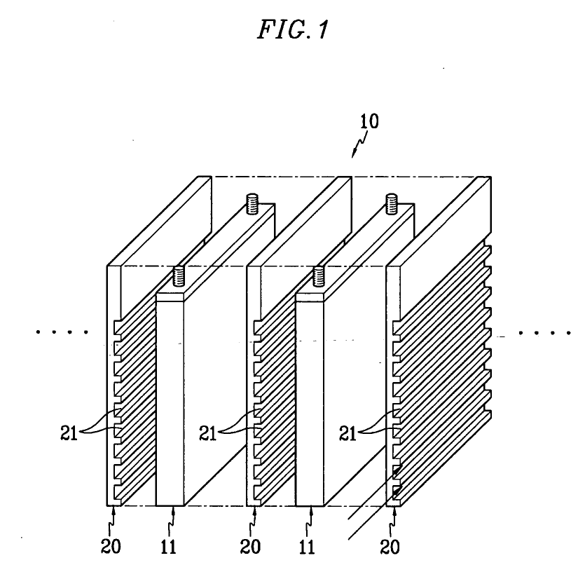

FIG. 1 is a schematic exploded perspective view illustrating a rechargeable battery module according to one embodiment of the present invention. The rechargeable battery module 10 includes a plurality of unit cells 11 that are disposed at particular intervals, and a heat sink plate 20 between each of the unit cells 11 for outwardly dissipating the heat generated thereby, and that is closely adhered to the entire surface of a unit cell 11.

The rechargeable battery module 10 can be mounted in a separate housing case (not shown). When air as a coolant (shown as an arrow) is supplied into the housing, the air passes the heat sink plate 20 disposed between the unit cells 11 and absorbs the heat generated by the unit cells 11. Then, when the air is released to the outside, the heat is dissipated with the air out of the battery.

According to this embodiment of the present invention, the heat sink plate 20 has the same size as the front surface of the unit cell 11, and a heat sink plate 20 is disposed between each unit cell 11. The heat sink plate 20 contacts one entire side of the unit cell 11 and protrudes beyond one edge thereof. The protruding part of the heat sink plate 20 contacts air as a coolant and plays a role of dissipating the heat transferred from the unit cell 11.

In addition, the heat sink plate 20 has cooling channels 21 formed as grooves and disposed at predetermined intervals on one entire surface thereof. Each cooling channel 21 is formed in a straight line from one end of the heat sink plate 20 to the other end thereof.

The heat sink plate 20 forms a path for circulating a coolant, when the surface of the heat sink plate 20 with the cooling channel 21 contacts one entire surface of the unit cell 11. Accordingly, the heat sink plate 20 improves cooling effects by dissipating heat through air as a coolant as well as through itself.

The heat sink plate 20 includes aluminum, an aluminum alloy, or a metal composite material. However, any material with high thermal conductivity can be used to outwardly dissipate the heat transferred from the unit cell 11, without particular limits.

The cooling channel 21 according to this embodiment of this invention has a cross section of a square or rectangle in a width direction. However, the present invention is not limited thereto and the cooling channel 21 can have various shapes.

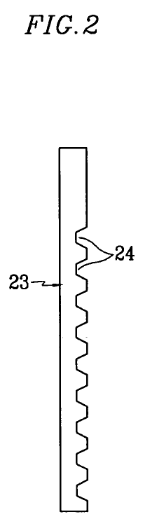

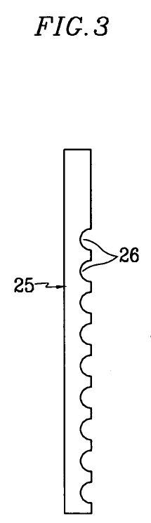

For example, as shown in FIG. 2, a cooling channel 24 formed on a heat sink plate 23 can have a side cross section of a trapezoid, and as shown in FIG. 3, a cooling channel 26 formed on a heat sink plate 25 can have an arch-shaped cross section.

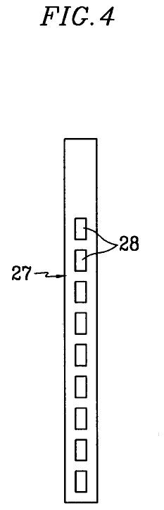

According to another embodiment of the present invention, a heat sink plate 27 can have a plurality of holes 28 penetrating through ends of the heat sink plate 27 as shown in FIG. 4. Accordingly, a coolant passes though the holes 28 in a direction parallel to the plane of the unit cells and dissipates the heat transferred from the unit cells to the heat sink plate 27 when it is released to the outside. Here, the holes 28 can be square, rectangular, circular, or polygonal.

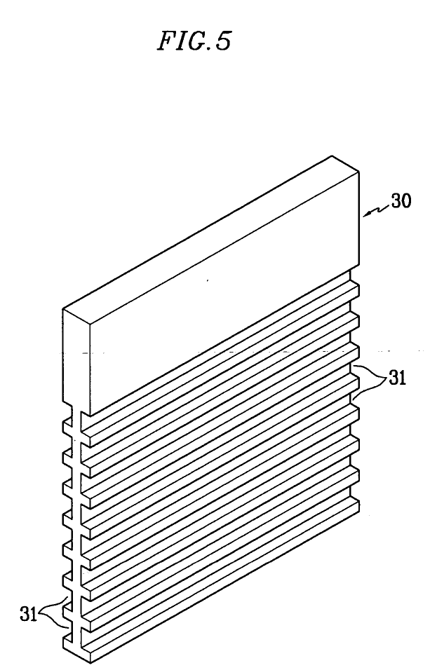

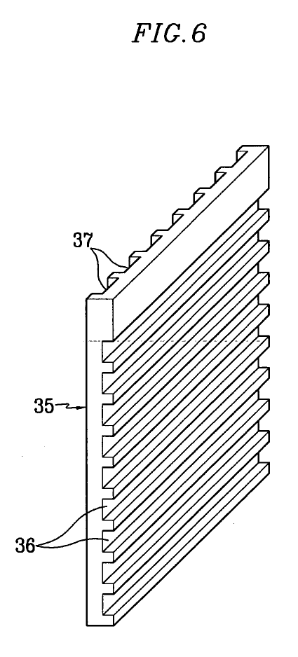

Further, FIGS. 5 and 6 illustrate additional embodiments of a heat sink plate. Referring to FIG. 5, a heat sink plate 30 has a plurality of cooling channels 31 formed as grooves on both sides thereof at particular intervals. Here, the cooling channels 31 are aligned on both sides of the heat sink plate 30 in the same width direction.

However, as shown in FIG. 6, cooling channels 36 and 37 formed on both sides of a heat sink plate 35 can be formed to perpendicularly cross each other. In other words, one cooling channel 36 formed on one side of the heat sink plate 35 is aligned in the width direction of the heat sink plate 35, while the other cooling channel 37 is aligned on the other side thereof in the length direction. Accordingly, a coolant can flow through at least one cooling channel 36 or 37 formed on either side of the heat sink plate 35, thereby cooling unit cells regardless of the flow direction of the coolant.

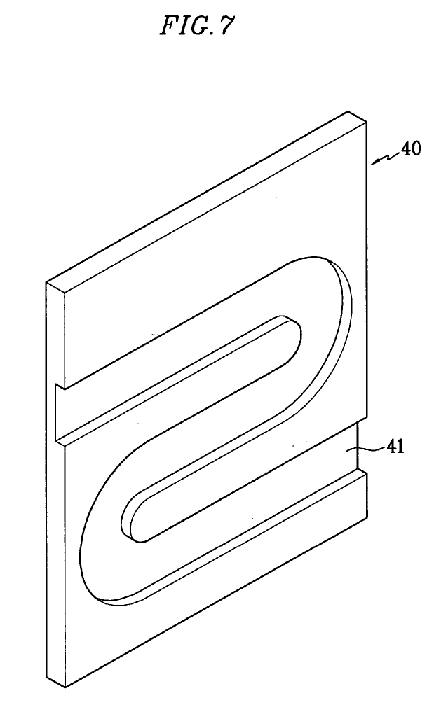

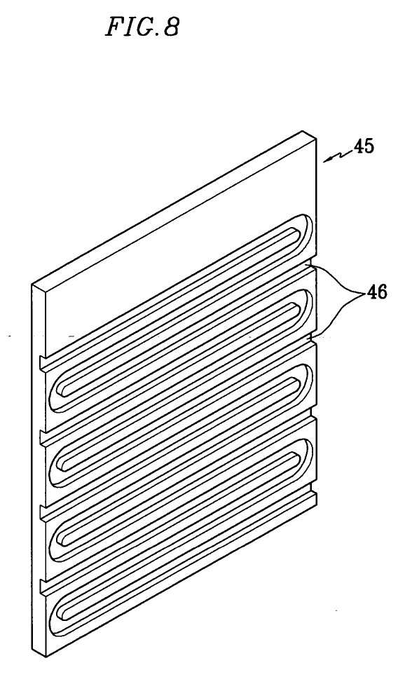

FIGS. 7 and 8 illustrate a heat sink plate fabricated according to other embodiments of the present invention.

As illustrated in FIG. 7, a cooling channel 41 with a curved structure is formed on the surface of a heat sink plate 40. The cooling channel 41 is recessed in the thickness direction from one end of the heat sink plate 40 to the other end thereof while forming a winding path. The cooling channel 41 is curved enough to sufficiently exchange heat with the heat sink plate 40. In other words, the cooling channel 41 is formed from one end of the heat sink plate 40 to the other end thereof as a long path. It then curves at the other end thereof at an angle of 180° toward the one end.

Then, the cooling channel 41 straightly extends to the end where it started and curves there again at an angle of 180° toward the other end. It extends to the other end of the heat sink plate 40 again, consequently forming a channel to both ends of the heat sink plate 40. In this way, the cooling channel 41 is formed in an S shape on the heat sink plate 40.

According to this embodiment of the present invention, the S-shaped cooling channel 41 can be longer than a straight one, so that a coolant can cool the heat sink plate 40 for a longer time while passing through the longer path while contacting the heat sink plate 40.

In addition, a heat sink plate 40 can have one cooling channel 41 as illustrated in FIG. 7, but another heat sink plate 45 can have a plurality of cooling channels 46, as illustrated in FIG. 8.

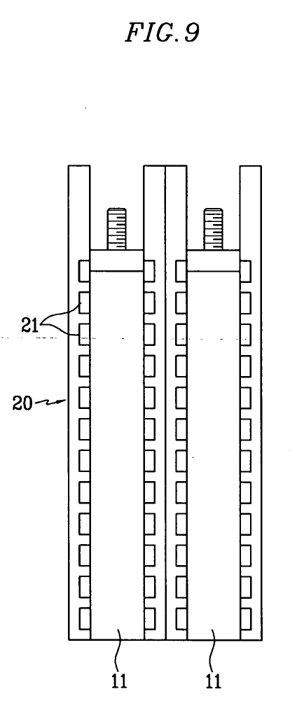

In addition, referring to FIG. 9, the heat sink plate 20 as shown in FIG. 1 can be mounted at both sides of the unit cells 11 that make up the rechargeable battery module. In other words, the heat sink plate 20 is closely adhered to the unit cell 11, so that the surface having the cooling channel 21 contacts the unit cell. Accordingly, each unit cell 11 has a heat sink plate 20 at both sides.

Therefore, the unit cells 11 can transfer heat to the heat sink plate 20 contacting the unit cells 11 at both sides, and the heat sink plate 20 and the cooling channel 21 formed thereon can outwardly dissipate the heat, lowering the temperature of the unit cells 11.

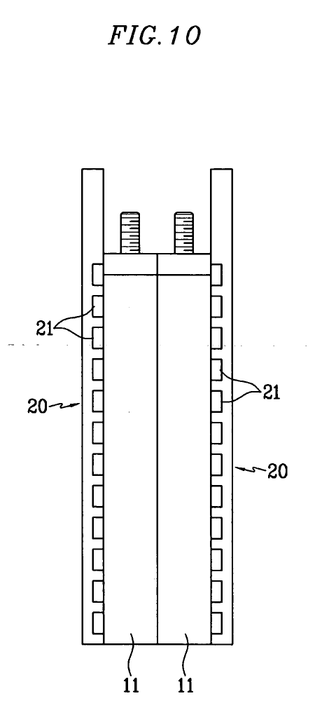

Referring to FIG. 10, the heat sink plate 20 can be mounted at both sides of two or more than two unit cells.

In this way, the present invention not only maintains heat dissipation characteristics through the heat sink plate 20 and the cooling channel 21 mounted thereon, but it can also reduce the volume of the rechargeable battery module by decreasing the number of heat sink plates 20 mounted thereon.

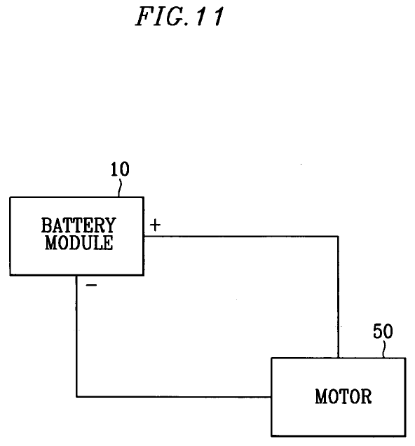

FIG. 11 is a schematic block chart illustrating how a rechargeable battery module 10 provided in FIG. 1 is connected with a motor 50.

According to various embodiments of the present invention, a rechargeable battery module can maximize a cooling effect by circulating a coolant through a heat sink plate as well as through a cooling channel formed on the heat sink plate.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A rechargeable battery module comprising:
a plurality of unit cells arranged at particular intervals;
a heat sink plate, mounted between the plurality of unit cells, adapted to dissipate heat generated by the plurality of unit cells; and
at least one cooling channel, adapted to circulate a coolant, formed on a first side of the heat sink plate.

2. The rechargeable battery module of claim 1, wherein the heat sink plate contacts one side of one of the plurality of unit cells and at least one edge of the heat sink plate protrudes beyond the one side of the one of the plurality of unit cells.

3. The rechargeable battery module of claim 1, wherein the heat sink plate comprises a material selected from the group consisting of aluminum, an aluminum alloy, and a metal composite material.

4. The rechargeable battery module of claim 1, wherein the at least one cooling channel is formed as a groove on the first side of the heat sink plate.

5. The rechargeable battery module of claim 4, wherein the at least one cooling channel has a cross section selected from the group consisting of a square, a rectangle, a trapezoid, and an arch.

6. The rechargeable battery module of claim 4, wherein the at least one cooling channel is further formed on a second side of the heat sink plate.

7. The rechargeable battery module of claim 6, wherein the at least one cooling channel on the first side and the second side of the heat sink plate are respectively aligned in a same direction.

8. The rechargeable battery module of claim 6, wherein the at least one cooling channel on the first side and the second side of the heat sink plate are respectively aligned in different directions.

9. The rechargeable battery module of claim 1, wherein the at least one cooling channel has at least one curved portion.

10. The rechargeable battery module of claim 9, wherein the at least one curved portion is positioned at an edge region of the heat sink plate, and curves at an angle of 180°.

11. The rechargeable battery module of claim 1, further comprising a second heat sink plate, wherein a one of the plurality of unit cells is disposed between the heat sink plate and the second heat sink plate.

12. The rechargeable battery module of claim 1, further comprising a second heat sink plate, wherein two or more of the plurality of unit cells are disposed between the heat sink plate and the second heat sink plate.

13. The rechargeable battery module of claim 1, wherein the heat sink plate is supplied with air as the coolant.

14. The rechargeable battery module of claim 1, wherein the cooling channel is supplied with water as the coolant.

15. The rechargeable battery module of claim 14, wherein the water supplied to the cooling channel is cold.

16. The rechargeable battery module of claim 1, wherein the rechargeable battery module is adapted for driving a motor.

17. A rechargeable battery module comprising:
a plurality of unit cells arranged at particular intervals;
a heat sink plate, mounted between the plurality of unit cells, adapted to dissipate heat generated by the plurality of unit cells; and
at least one cooling channel, adapted to circulate a coolant, formed as a hole penetrating the heat sink plate.

18. A rechargeable battery module comprising:
a plurality of unit cells;
a first heat sink plate positioned between neighboring ones of the plurality of unit cells and having at least one cooling channel; and
a coolant positioned within the at least one cooling channel.

19. The rechargeable battery module of claim 18, wherein the at least one cooling channel is positioned on a side of the first heat sink plate.

20. The rechargeable battery module of claim 18, wherein the at least one cooling channel passes through the first heat sink plate.

21. A method for dissipating heat from a plurality of unit cells arranged at particular intervals comprising:
providing a heat sink having a channel adapted to circulate a coolant;
positioning a heat sink between neighboring ones of the plurality of unit cells; and
supplying a coolant to the channel.
